(19) United States
(12) Patent Application Publication
(10) Pub. No.: US 2013/0126539 A1
(43) Pub. Date: May 23, 2013

(54) Dimpled Surface for Pressurized Container

(71) Applicant: PepsiCo, Inc., Purchase, NY (US)

(72) Inventors: Charles White, Parsippany, NJ (US); Thomas Holland, Pleasant Valley, NY (US)

(73) Assignee: PEPSICO, INC., Purchase, NY (US)

(21) Appl. No.: 13/668,872

(22) Filed: Nov. 5, 2012

Related U.S. Application Data
(60) Provisional application No. 61/561,370, filed on Nov. 18, 2011.

(51) Int. Cl. B65D 90/36; B67D 7/06; B67D 7/72

(52) U.S. Cl. 220/721; 222/394; 222/23

(57) ABSTRACT

A container configured to be pressurized is described. The container may include a top surface, a bottom surface, and one or more sidewalls extending between the top surface and the bottom surface. One or more surfaces of the container, such as the bottom surface, may include a plurality of dimples. The dimples may be configured to extend inwardly into the container when the container is not under pressure and extend outwardly from one of the surfaces of the container when the container is under pressure. The container may include components configured to dispense liquid from the container and a pressure control device to pressurize the container.

### CROSS REFERENCE TO RELATED APPLICATIONS

This Application claims priority to U.S. Provisional Application Ser. No. 61/561,370, filed Nov. 18, 2011.

### FIELD OF THE INVENTION

The invention relates generally to a design for one or more surfaces of a pressurized container.

### BACKGROUND OF THE INVENTION

Pressurized metal containers, such as kegs typically use flat metal sheets on the bottom end of the container. As the pressure increases in a metal container, the bottom end of the container buckles outwardly. This buckling may cause the bottom of a container to form a generally convex shape, such that the container will rock or move when placed on a flat surface. Customers purchasing the metal containers may believe the contents inside the container are defective if the outside of the container has a defect, such as the buckled container bottom.

To counteract the buckling of the bottom of a pressurized container, manufacturers of pressurized metal containers have incorporated a concave or dome shaped bottom end. However, the dome or concave shaped end may reduce the internal capacity of the pressurized container. Manufacturers have also used thicker pieces of metal on the bottom end of the container. However, using thicker pieces of metal increase the costs of goods and increase the cost to manufacture the pressurized container. Aspects of the disclosure provide a more effective design for a pressurized metal container.

### BRIEF SUMMARY OF THE INVENTION

The present invention provides a design for a surface on pressurized containers, such as kegs, that controls the pressure within the containers. In at least one aspect of the invention, a plurality of shallow depressions or dimples are arranged on one or more surfaces of a pressurized metal container. In response to an increase of pressure within the pressurized container, one or more of the dimples “pops out” or extends outwardly from the surface of the pressurized container to relieve the pressure within the container. The dimples may pop out one at a time or a plurality of dimples may pop out at the same time depending on the amount of pressure within the pressurized container.

The dimples may be arranged in on the surface of the pressurized container to form shapes or logos. In accordance with at least one aspect, the dimples are arranged to form a logo of the manufacturer of the liquid within the pressurized container. In at least one embodiment, the dimples are located on the bottom surface of the pressurized container.

### BRIEF DESCRIPTION OF THE DRAWINGS

FIG. 1A illustrates a side view of a pressurized container in accordance with aspects of the invention.

FIG. 1B illustrates a top view of the pressurized container in accordance with aspects of the invention.

FIG. 2A illustrates bottom view of the pressurized container in accordance with an exemplary embodiment of the invention.

FIG. 2B illustrates bottom view of the pressurized container in accordance with an alternative exemplary embodiment of the invention.

FIG. 2C illustrates bottom view of the pressurized container in accordance with a further alternative exemplary embodiment of the invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

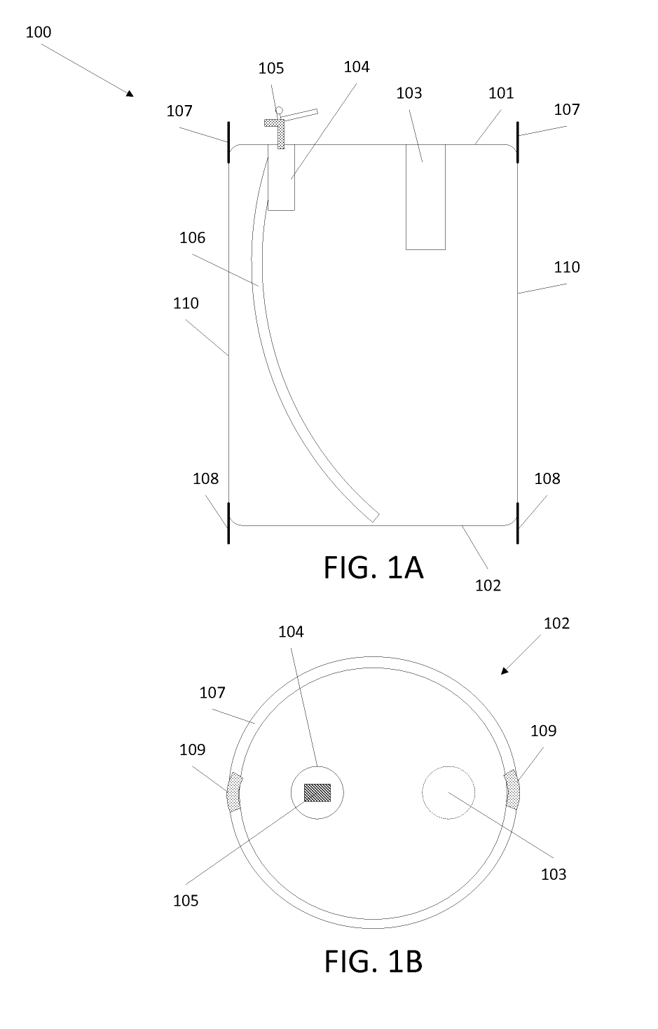

A pressurized container 100 is generally illustrated in FIG. 1A. The pressurized container 100 may be any suitable shape or size for holding a pressurized liquid. For example, the pressurized container may hold volumes of approximately 5 L, 5 gal, 8 gal, or 15.5 gal. In at least one embodiment, the pressurized container 100 is configured to hold a carbonated beverage. The pressurized container 100 may be generally cylindrical in shape or may be any other suitable shape, such as rectangular or circular. The pressurized container 100 may be made of any suitable material. In at least one embodiment, the pressurized container 100 is made from a metal, such as stainless steel or aluminum.

Referring to FIG. 1A, the pressurized container 100 may include a top surface 101, a bottom surface 102, and one or more side walls 110. The top surface 101 may have a rim or protrusion 107 extending outwardly from the top surface 101. In at least one embodiment, the rim or projection 107 extends around the entire circumference of the top surface 101 of the pressurized container 100. The rim or protrusion 107 may include one or more apertures or handles 109, as illustrated in FIG. 1B, to allow a person to grip and/or carry the pressurized container 100. Referring back to FIG. 1A, the pressurized container 100 may also include a rim or projection 108 extending outwardly from the bottom surface 102. In at least one embodiment, the rim or projection 108 extends around the entire circumference of the bottom surface 102.

The pressurized container 100 may contain any necessary components for dispensing the pressurized liquid. For example, the pressurized container 100 may include a tapping or dispensing device 105, a valve assembly 104, a spear or tube 106, and a pressure control device 103. The tapping device 105 may include any necessary components to dispense the pressurized liquid from the pressurized container 100, including a handle and a nozzle. The pressurized container 100 may include one or more openings. In at least one embodiment, the top surface 101 includes one opening configured to house the valve assembly 104. The valve assembly 104 may include any suitable components for opening and closing the opening in the pressurized container 100, such as one or more valves and fittings. The valve assembly 104 is configured to attach to the tapping device 105.

The spear or tube 106 may attach to the valve assembly 104 and may extend to the bottom surface 102 of the pressurized container 100. The spear 106 may be a hollow tube that allows the liquid in the pressurized container 100 to pass through it and into the valve assembly 104. The pressure control device 103 may be any suitable device for controlling pressure in the pressurized container 100. In at least one embodiment, the pressure control device 103 includes carbon dioxide for pressurizing the liquid. The pressure control device 103 may be positioned in any suitable location within or partially within the pressurized container 100. For example, as illustrated in FIG. 1A, the pressure control device 100 may be located within the pressurized container 100.

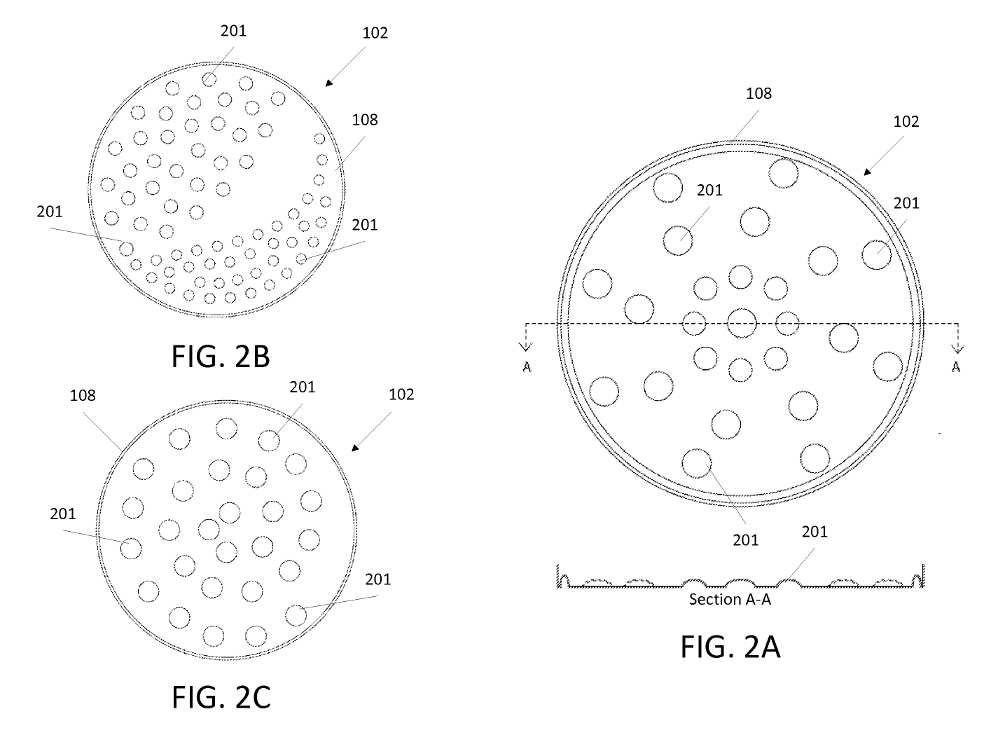

As illustrated in FIGS. 2A, 2B, and 2C, the pressurized container 100 may include a plurality of shallow depressions or dimples 201 that extend inwardly into the interior of the pressurized container 100. The dimples 201 are configured to “pop out” or extend outwardly in response to pressure increases within the pressurized container 100, as illustrated in Section A-A of FIG. 2A. As the pressure increases within the pressurized container 100, the dimples 201 flex or extend outwardly in a subtle, controlled manner to relieve the pressure within the pressurized container 100. The dimples 201 may pop out one at a time or a plurality of dimples 201 may pop out at the same time.

In at least one embodiment, the plurality of dimples 201 are located on the bottom surface 102 of the pressurized container 100. However, the dimples 201 may be located on any surface of the pressurized container 100, including the side walls 110 and/or the top surface 101. The dimples 201 may be manufactured in any suitable manner. For example, the dimples 201 may be embossed into the surface(s) of the pressurized container 100. In at least one embodiment, the bottom surface 102 of the pressurized container 100 is created by punching the shape of the bottom surface 102 from a flat metal sheet. In this embodiment, the dimples 201 are embossed in the bottom surface 102 at the same time the bottom surface 102 is being punched from the metal sheet.

The dimples 201 may be arranged in any desirable pattern. For example, as illustrated in FIG. 2A, the dimples 201 may be arranged in a “starburst” pattern, such that a plurality of dimples 201 extend outwardly from a plurality of dimples arranged concentrically in the center of the surface. The dimples 201 may also be arranged in a spiral configuration, as illustrated in FIG. 2C. Additionally, the dimples 201 may be arranged to form a logo, as illustrated in FIG. 2B. The dimples 201 may be or the color of the pressurized container 100 or may be colored. In at least one embodiment, the dimples 201 contain colors and are arranged in a manner that is indicative of the logo of the manufacturer of the pressurized container 100 or the liquid within the pressurized container 100.

Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. A container comprising:
a top surface defining a top rim extending upwardly from the top surface;
a bottom surface defining a plurality of dimples; and
at least one sidewall, the at least one side wall extending between the top surface and the bottom surface,
wherein the plurality of dimples are configured to extend inwardly into the container when the container is not under pressure, and
wherein the plurality of dimples are configured to extend outwardly from the bottom surface when the container is under pressure.

2. The container of claim 1, wherein the top rim defines at least one aperture.

3. The container of claim 1, wherein the top rim defines a plurality of apertures.

4. The container of claim 1, further including:
a dispensing device configured to dispense liquid from the container;
a valve assembly connected to the dispensing device;
a tube connected to the valve assembly; and
a pressure control device, wherein the pressure control device is positioned within the container.

5. The container of claim 1, wherein the bottom surface defines a bottom rim extending outwardly from the bottom surface at an edge of the bottom surface.

6. The container of claim 5, wherein the bottom rim extends around a circumference of the bottom surface.

7. The container of claim 1, wherein the plurality of dimples are arranged in a predefined shape.

8. The container of claim 7, wherein the predefined shape corresponds to a logo.

9. The container of claim 7, wherein the predefined shape is a spiral.

10. The container of claim 7, wherein the predefined shape is a starburst.

11. A container comprising:
a top surface defining a top rim extending upwardly from the top surface, the top rim defining at least one aperture;
a bottom surface defining a plurality of dimples and a bottom rim extending outwardly from the bottom surface; and
a plurality of sidewalls, the plurality of sidewalls extending between the top surface and the bottom surface,
wherein the plurality of dimples are configured to extend inwardly into the container when the container is not under pressure, and
wherein the plurality of dimples are configured to extend outwardly from the bottom surface when the container is under pressure.

12. The container of claim 1, wherein the plurality of sidewalls each include a plurality of sidewall dimples.

13. The container of claim 12, wherein the plurality of sidewall dimples are configured to extend inwardly into the container when the container is not under pressure, and wherein the plurality of sidewall dimples are configured to extend outwardly from one of the plurality of sidewalls when the container is under pressure.

14. The container of claim 11, wherein the plurality of dimples on the bottom surface are arranged in a predefined shape.

15. The container of claim 14, wherein the predefined shape corresponds to a logo.

16. The container of claim 14, wherein the predefined shape is a spiral.

17. The container of claim 14, wherein the predefined shape is a starburst.

18. A container comprising:
a top surface defining a top rim extending upwardly from the top surface;
a bottom surface defining a plurality of dimples;
at least one sidewall, the at least one side wall extending between the top surface and the bottom surface;
a dispensing device configured to dispense liquid from the container;
a valve assembly connected to the dispensing device;
a tube connected to the valve assembly; and
a pressure control device, wherein the pressure control device is positioned within the container,
wherein the plurality of dimples are configured to extend inwardly into the container when the container is not under pressure, and
wherein the plurality of dimples are configured to extend outwardly from the bottom surface when the container is under pressure.

19. The container of claim 18, wherein the pressure control device is configured to control the pressure within the container.

20. The container of claim 18, wherein the at least one sidewall includes a plurality of sidewall dimples, wherein the plurality of sidewall dimples are configured to extend inwardly into the container when the container is not under pressure, and wherein the plurality of sidewall dimples are configured to extend outwardly from the sidewall when the container is under pressure.
